(19) United States
(12) Patent Application Publication
(10) Pub. No.: US 2002/0083451 A1
(43) Pub. Date: Jun. 27, 2002

(54) User-friendly electronic program guide based on subscriber characterizations

(76) Inventors: Komlika K. Gill, Cherry Hill, NJ (US); Charles A. Eldering, Doylestown, PA (US)

Correspondence Address: EXPANSE NETWORKS, INC., 300 NORTH BROADSTREET, DOYLESTOWN, PA, 18901, US

(21) Appl. No.: 09/742,507

(22) Filed: Dec. 21, 2000

(51) Int. Cl. H04N 7/16; H04H 9/00; G06F 3/00; H04N 5/445; G06F 13/00

(52) U.S. Cl. 725/46; 725/9; 725/14

(57) ABSTRACT

Monitoring a subscriber's 120 viewing activities and creating a subscriber characterization. The subscriber characterization is then used to create the subscriber's preferred categories of programming, and to configure the display of an Electronic Program Guide (EPG) 140 or other suitable guide system in accordance with the subscriber characterizations. The EPG 140 includes one or more specifically preferred categories that indicate what the subscriber 120 is interested in, e.g., the highly watched programming, etc., as well as what may be of interest to the subscriber 120 based on his/her subscriber characterizations. Generally, the EPG 140 presents the preferred programming/category at the top of the EPG guide providing easy access to the subscriber's favorites. Thus, the EPG screen transmitted to the subscriber is a customized screen based on subscriber characteristics.

### BACKGROUND OF THE INVENTION

Television viewing is a popular activity, and the number of available television channels has grown substantially since the early days of broadcast television, thereby providing subscribers with greatly increased choices in programming. Programming guides have become important subscriber tools, and indeed, are essential for efficiently locating desired programs.

Paper guides, such as those provided with newspapers, are plentiful but suffer from many drawbacks. These drawbacks include possible preemption after printing and the sheer amount of information placed before the reader with little, if any, visual distinction between programs. A reader interested in only a subset of the available programming is forced to search the entire listing to locate the desired program or programs.

More recent alternatives to paper guides, known as Electronic Program Guides (EPG), have been developed. EPGs provide television program listings directly on the subscriber's television screen, and generally, eliminate the possibility of relying on an obsolete paper guide, because the program listings can be updated in real-time by the EPG provider. U.S. Pat. No. 5,353,121 issued Oct. 4, 1994 to Young discloses such an EPG, wherein information is displayed on the subscriber's television screen.

In addition to providing on-screen program listings, EPGs also allow a subscriber to tune to a desired program. If a program is listed in the program guide, a user can select the channel by interacting with the EPG via a remote control instead of manually changing channels. EPGs typically present the television listings in a grid format and give the subscriber control over a cursor or pointer with which to make selections. The grid may be organized in such a manner that one axis represents time and the other represents programming channels. Such grids typically present the program channels in a sequential manner, such as numeric order by channel number or alphabetic order by programming source or other identifier.

Although known EPGs grant subscribers the convenience of identifying available television programs without resorting to other sources of information, shortcomings still exist. For example, a subscriber who greatly prefers sports programs over other programming will still have to search the entire grid of available programs to find those involving sporting events of interest. Further, although some televisions and television scheduling systems allow subscribers to pre-specify certain channels as “Favorite” channels, not every subscriber of a given television receiver will prefer the same favorite channels, and any one subscriber's favorites may change over time, thereby reducing the effective of that feature. Furthermore, the “Favorite” channels are based on previous viewing habits, not on subscriber characterization. The prior art mechanisms do not include any information processing to determine different programming that may be of interest to the subscriber.

### SUMMARY OF THE INVENTION

In view of the above disadvantages of the related art, it is an object of the present invention to provide a method and apparatus for monitoring a subscriber's viewing activities and creating a subscriber characterization. The subscriber characterization is then used to create the subscriber's preferred categories of programming, and to configure the display of an Electronic Program Guide (EPG) or other suitable guide system in accordance with the subscriber characterizations. The EPG includes one or more specifically preferred categories that indicate what the subscriber is interested in, e.g., highly watched programming, as well as what may be of interest to the subscriber based on his/her subscriber characterizations. For example, if the subscriber characterization illustrates that the subscriber is a single female in her forties and generally watches movies, the Lifetime Channel (having movies dedicated to women's themes) may be considered preferred programming/category.

Generally, the EPG presents the preferred programming/category at the top of the EPG guide providing easy access to the subscriber's favorites. Thus, the EPG screen transmitted to the subscriber is a customized screen based on subscriber characteristics.

In accordance with the present invention, also provided is a method for monitoring television viewing behavior and determining subscriber characterizations. This method may illustratively be used to configure and display EPG information on the screen of a television in accordance with subscriber characterizations and/or automatically switch through preferred programming options for ease of subscriber selection.

In one exemplary embodiment of the invention, an apparatus for monitoring viewing behavior is provided which includes a means for establishing a subscriber profile for determining preferred viewing statuses. In this embodiment, the subscriber's viewing behavior is regularly monitored and the corresponding subscriber characterizations are regularly updated. The subscriber characterization system further includes an EPG Server (EPGS) that receives information about the subscriber characterizations, and configures a particular EPG screen based on the corresponding subscriber characteristics.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIGS. 1A and 1B illustrate a context diagram of one embodiment of the present invention;

FIG. 2 illustrates a channel sequence and volume over a twenty-four (24) hour period;

FIG. 3A illustrates a detailed record of raw subscriber selection data in a table format;

FIG. 3B illustrates a channel surfing graph;

FIG. 3C illustrates processing involved in the elimination of viewing times associated with channel jumping activities;

FIG. 4 illustrates a representative statistical record corresponding to household viewing habits;

FIG. 5A illustrates an entity-relationship diagram for the generation of a program characteristics vector;

FIG. 5B describes the program characterization process;

FIGS. 6A-F depict the program characteristics vectors;

FIG. 7A illustrates set of logical heuristics rules;

FIG. 7B illustrates a set of heuristic rules expressed in terms of conditional probabilities;

FIG. 8 illustrates an entity-relationship diagram for the generation of the program demographic vectors;

FIG. 9 illustrates an example of a program demographic vector;

FIG. 10 illustrates an entity-relationship diagram for the generation of household session demographic data and a household session interest profile;

FIG. 11 illustrates an entity-relationship diagram for the generation of average household demographic characteristics and session household demographic characteristics;

FIG. 12 illustrates average and session household demographic characteristics;

FIG. 13 illustrates an entity-relationship diagram for the generation of the household interest profile in a household interest profile generation process;

FIG. 14 illustrates household interest profile which is composed of a programming types row, a products types row, a household interests column, an average value column, and a session value column; FIG. 15 demonstrates how a typical electronic program guide display may appear without using the novel subscriber profile of the present invention; and

FIG. 16 illustrates a display of an electronic program guide in accordance with the principles of the present invention.

### DETAILED DESCRIPTION

### OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

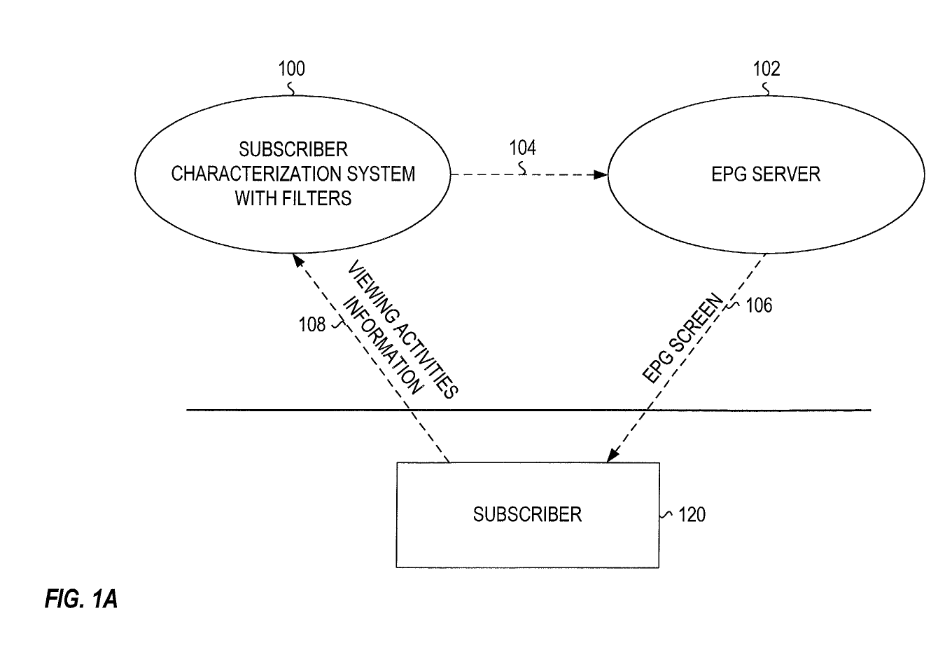

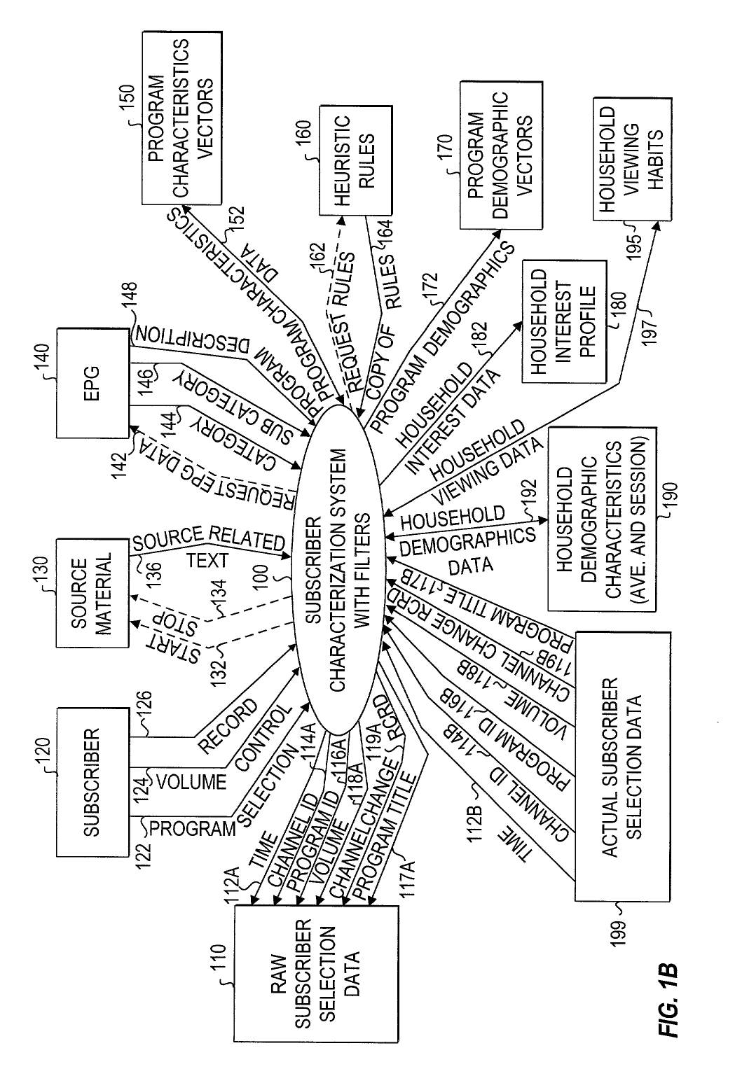

With reference to the drawings, in general, and FIGS. 1 through 16 in particular, the apparatus of the present invention is disclosed.

The present invention will be described in the context of Electronic Program Guides (EPG) and general television viewing, although those of ordinary skill in the art will recognize that the disclosed methods and structures are readily adaptable for broader application.

A television viewing environment typically incorporates a television, a subscriber interface, a subscriber interface remote control, and one or more subscribers. Subscriber interfaces are known in the art, and are generally found in the form of a television set-top unit. The subscriber interface is often connected to, and between, the television and television program/broadcast sources such as cable and satellite. The subscriber interface receives input in the form of television programs and television program guide information from the various broadcast sources. The subscriber interface may also perform additional functions such as decoding and encoding of the television programming.

The subscriber interface also includes a means for accepting subscriber commands, such as to change television channels, from the remote control. However, the remote control is merely one means by which a subscriber may input commands to the subscriber interface and/or the EPG. For example, subscribers may input commands directly into the subscriber interface.

In accordance with the present invention, a subscriber profile is provided for use in the above-described television viewing environment that will monitor a subscriber's viewing behavior to determine the subscriber characterizations including preferred channels and the types or categories of television programming that the subscriber prefers on those channels. The subscriber profile of the present invention possesses several advantages over the prior art. Drawing upon its stored information, the subscriber profile will operate in conjunction with an EPGS that provides EPG screens to the subscriber having the subscriber's preferred channels as well as the programs that may be of interest to the subscriber based on subscriber characterizations. Additionally, the information captured by the subscriber profile can be used to tailor the EPG's presentation of television program guide information so as to provide faster access to information concerning the subscriber's preferred channels and/or programming categories. Furthermore, the EPG screen may include the channel and/or programming categories that are found to be of interest to the subscriber based on subscriber characterizations. Further, because the subscriber profile can store profiles of numerous subscribers, the tailored programming lists can be subscriber-specific. In addition, the subscriber profile can be used to lock out specified channels or categories of programming, or to limit the amount of time such channels or categories may be viewed. The subscriber profile can also be used to identify and provide information of interest from the Internet.

The subscriber profile may be implemented in software and, like the EPG, downloaded into the subscriber interface via an interactive television network or other means for loading software. In another exemplary embodiment, the subscriber profile may be implemented as resident software in the subscriber interface.

The present invention is directed at an apparatus for generating a subscriber profile that contains useful information regarding the subscriber likes and dislikes. Such a profile is useful for systems which provide targeted programming or advertisements to the subscriber, and allow material (programs or advertisements) to be directed at subscribers who will have a high probability of liking the program or a high degree of interest in purchasing the product.

Since there are typically multiple individuals in a household, the subscriber characterization may not be a characterization of an individual subscriber but may instead be a household average. When used herein, the term subscriber refers both to an individual subscriber characterization as well as the average characteristics of a household of multiple subscribers.

In the present system the programming viewed by the subscriber, both entertainment and advertisement, can be studied and processed by the subscriber characterization system. In this study, system filters are configured to eliminate selection data associated with irrelevant activities from the actual selection data. The actual selection data is then used to determine the program characteristics. This determination of the program characteristics is referred to as a program characteristics vector. This vector may be a truly one-dimensional vector, but can also be represented as an n dimensional matrix which can be decomposed into vectors.

The subscriber profile vector represents a profile of the subscriber (or the household of subscribers) and can be in the form of a demographic profile (average or session) or a program or product preference vector. The program and product preference vectors are considered to be part of a household interest profile which can be thought of as an n dimensional matrix representing probabilistic measurements of subscriber interests.

In the case that the subscriber profile vector is a demographic profile, the subscriber profile vector indicates a probabilistic measure of the age of the subscriber or average age of the viewers in the household, sex of the subscriber, income range of the subscriber or household, and other such demographic data. Such information comprises household demographic characteristics and is composed of both average and session values. Extracting a single set of values from the household demographic characteristics can correspond to a subscriber profile vector.

The household interest profile can contain both programming and product profiles, with programming profiles corresponding to probabilistic determinations of what programming the subscriber (household) is likely to be interested in, and product profiles corresponding to what products the subscriber (household) is likely to be interested in. These profiles contain both an average value and a session value, the average value being a time average of data, where the averaging period may be several days, weeks, months, or the time between resets of unit.

Since a viewing session is likely to be dominated by a particular viewer, the session values may, in some circumstances, correspond most closely to the subscriber values, while the average values may, in some circumstances, correspond most closely to the household values.

FIG. 1A illustrates a context diagram of one embodiment of the present invention. The system, in accordance with this embodiment, comprises a subscriber characterization system (SCS) 100 coupled directly or indirectly to an Electronic Program Guide Server (EPGS) 102. The SCS 100 is responsible for monitoring one ore more viewing activities of a subscriber 120 and collecting viewing activity information via a direct or indirect link 108. The SCS 100 also utilizes the collected viewing activity information to create one or more subscriber characterizations. The feedback about the subscriber characterizations is provided to the EPGS 102 via a direct or indirect link 104. The EPGS 102 utilizes the subscriber characterization information to create the subscriber's 120 preferred categories of programming, and to configure the display of an Electronic Program Guide (EPG) or other suitable guide system in accordance with the preferred programming. The EPG screen via an indirect or direct link 106 is then transmitted from the EPGS 102 to the subscriber 120.

The transmitted EPG screen includes one or more specifically preferred categories that indicate what the subscriber 120 is interested in, e.g., the highly watched programming, etc., as well as what may be of interest to the subscriber 120 based on his/her subscriber characterizations. For example, if the subscriber characterization illustrates that the subscriber 120 is a single female in her forties and generally watches movies, the Lifetime Channel (having movies dedicated to women's themes) may be considered preferred programming/category.

Generally, the EPG presents the preferred programming/category at the top of the EPG guide providing easy access to the subscriber's 120 favorites. Thus, the EPG screen transmitted to the subscriber 120 is a customized screen based on subscriber characteristics.

The SCS 100 also comprises one or more filters that may be a computer means or a software module configured with some predetermined rules. These predetermined rules assist in recognizing irrelevant activities and the elimination of selection data from raw subscriber selection data. Filters and their related processing are described in detail later.

The present invention can be realized in a number of programming languages including C, C++, Perl, and Java, although the scope of the invention is not limited by the choice of a particular programming language or tool. Object oriented languages have several advantages in terms of construction of the software used to realize the present invention, although the present invention can be realized in procedural or other types of programming languages known to those of ordinary skill in the art.

FIG. 1B illustrates a context diagram of one embodiment of the present invention. In the process of collecting raw subscriber selection data, the SCS 100 receives, from a subscriber 120, commands in the form of a volume control signal 124 or program selection data 122 which can be in the form of a channel change, but may also be an address request, which requests the delivery of programming from a network address. A record signal 126 indicates that the programming or the address of the programming is being recorded by the subscriber 120. The record signal 126 can also be a printing command, a tape recording command, a bookmark command or any other command intended to store the program being viewed, or program address, for later use.

The material being viewed by the subscriber 120 is referred to as source material 130. The source material 130, as defined herein, is the content that a subscriber 120 selects and may consist of analog video, Motion Picture Expert Group (MPEG) digital video source material, other digital or analog material, Hypertext Markup Language (HTML) or other type of multimedia source material. The SCS 100 can access the source material 130 received by the subscriber 120 using a start signal 132 and a stop signal 134, which control the transfer of source related text 136 which can be analyzed as described herein.

In a preferred embodiment, the source related text 136 can be extracted from the source material 130 and stored in memory. The source related text 136, as defined herein, includes source related textual information including descriptive fields which are related to the source material 130, or text which is part of the source material 130 itself. The source related text 136 can be derived from a number of sources including, but not limited to, closed-captioning information, EPG material, and text information in the source itself (e.g. text in HTML files).

An EPG 140 contains information related to the source material 130 which is useful to the subscriber 120. The EPG 140 is typically a navigational tool which contains source related information, including but not limited to, the programming category, program description, rating, actors, and duration. The structure and content of EPG data is described in detail in U.S. Pat. No. 5,596,373 assigned to Sony Corporation and Sony Electronics, which is herein incorporated by reference. As shown in FIG. 1B, the EPG 140 can be accessed by the SCS 100 by a request EPG data signal 142 which results in the return of a category 144, a sub-category 146, and a program description 148.

In one embodiment of the present invention, EPG data is accessed and program information such as the category 144, the sub-category 146, and the program description 148 are stored in memory.

In another embodiment of the present invention, the source related text 136 is the closed-captioning text embedded in the analog or digital video signal. Such closed-captioning text can be stored in memory for processing to extract program characteristic vectors 150.

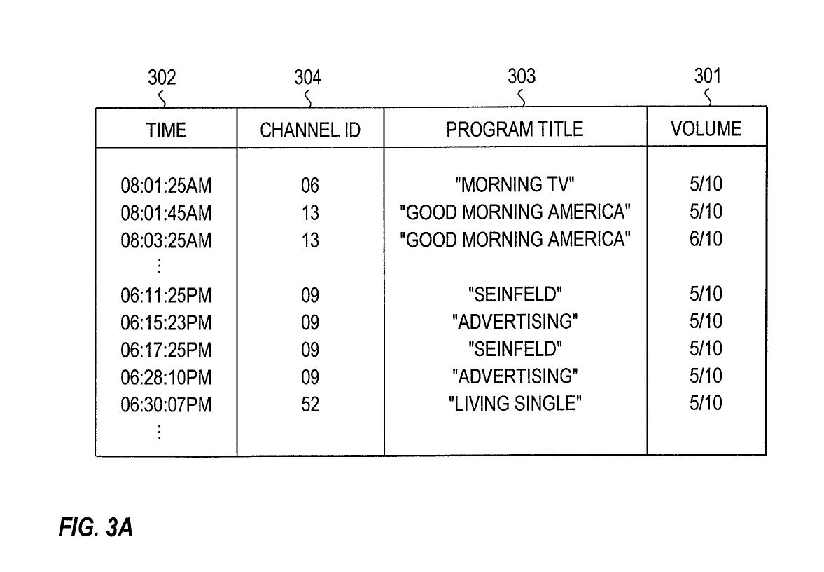

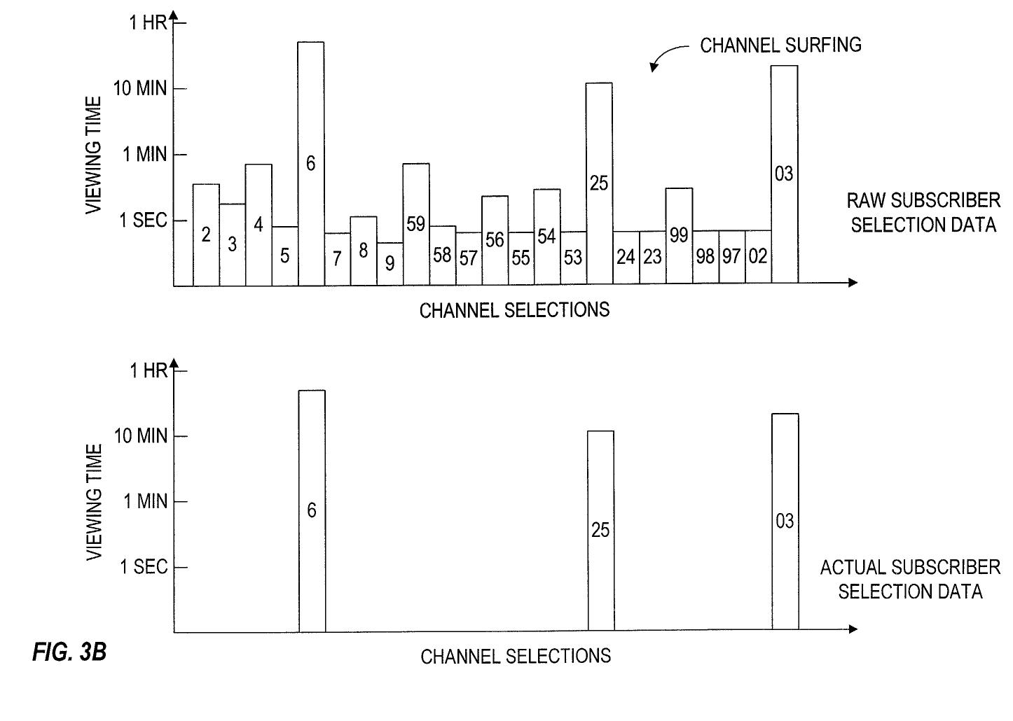

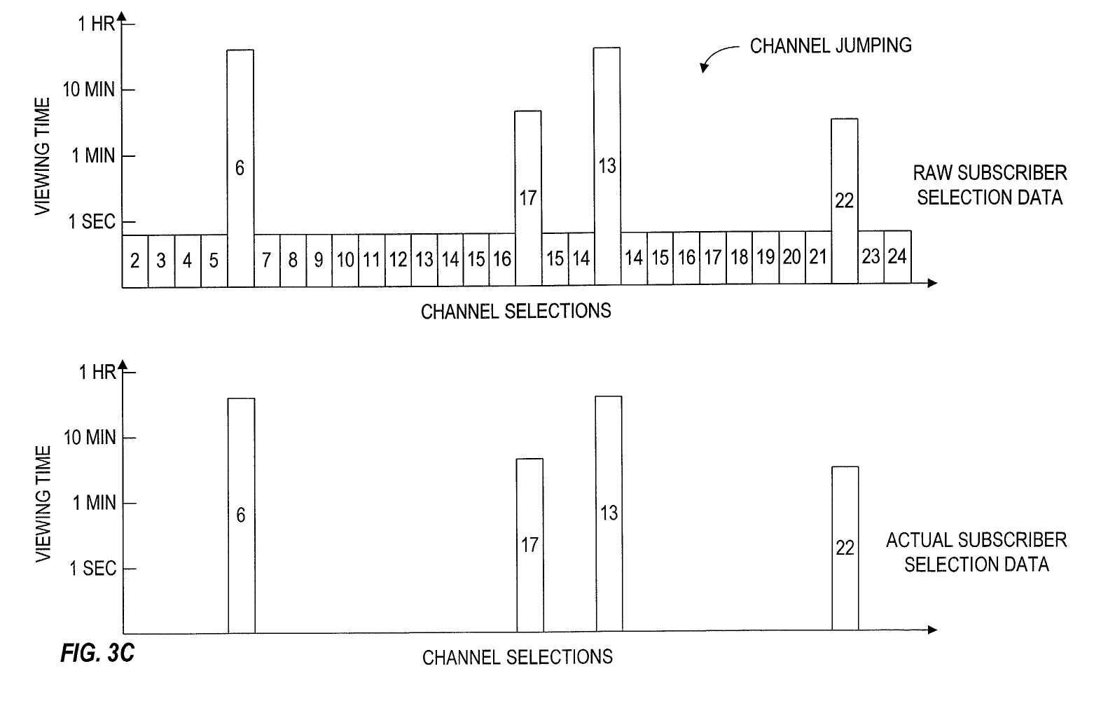

Raw subscriber selection data 110 is accumulated from the monitored activities of the subscriber 120. The raw subscriber selection data 110 includes time 112A, which corresponds to the time of an event, channel ID 114A, program ID 116A, program title 117A, volume level 118A, and channel change record 119A. A detailed record of such raw subscriber selection data 110 is illustrated in FIG. 3A and described in detail later herein.

Generally, the raw subscriber selection data 110 contains raw data accumulated over a predetermined period of time and relates to viewing selections made by the subscriber 120 over the predetermined period of time. The filters of the SCS 100 evaluate the raw subscriber selection data 110, eliminate any selection data associated with irrelevant activities, and in turn, generate actual subscriber selection data 199 that corresponds only to the actual viewing selections made by the subscriber 120. The actual subscriber selection data 199 comprises time 112B, which corresponds to the time of an actual viewing event exclusive of channel surfing, channel jumping or dead periods, channel ID 114B, program ID 116B, program title 117B, volume level 118B, and channel change record 119B.

The raw subscriber selection data 110 may be processed in accordance with some pre-determined heuristic rules 160 to generate actual subscriber selection data 199. In one embodiment, the selection data associated with channel surfing, channel jumping and dead periods is eliminated from the raw subscriber selection data 110 to generate actual subscriber selection data 199.

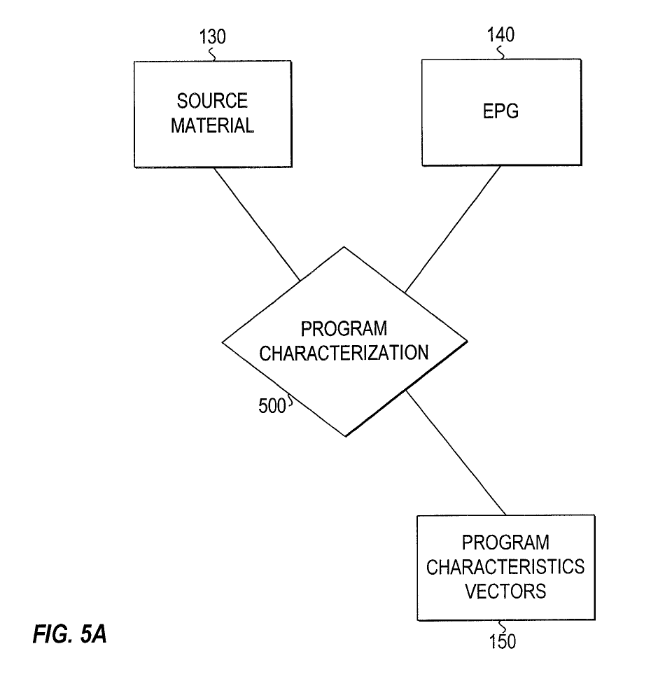

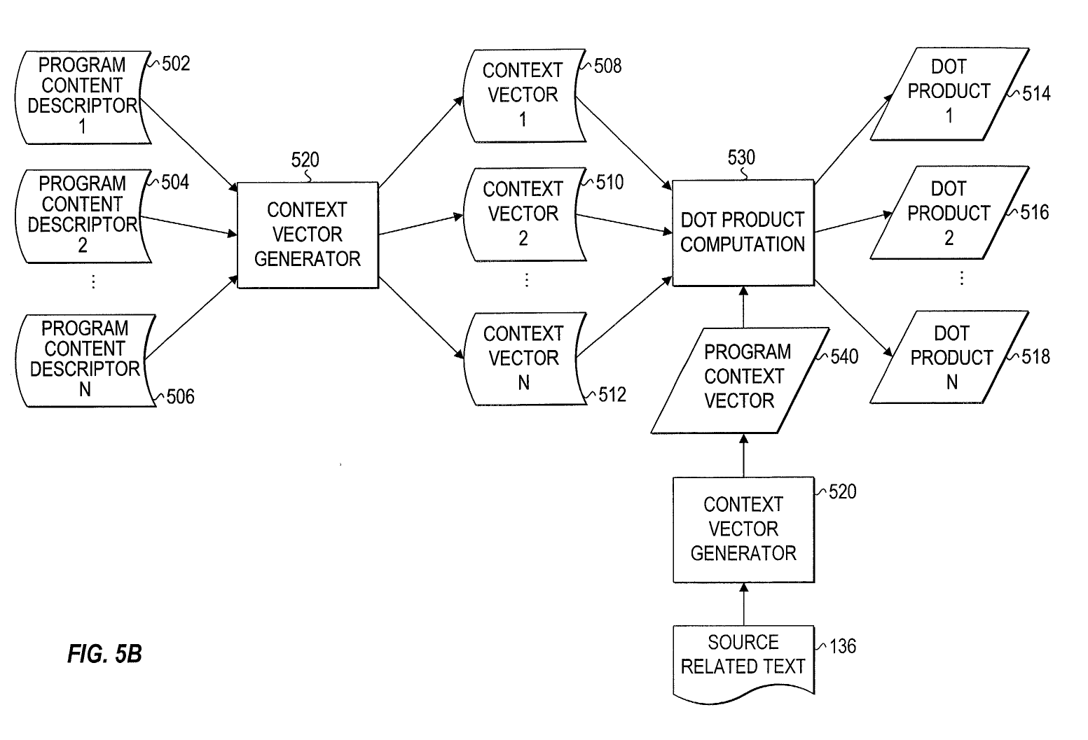

Based on the actual subscriber selection data 199, the SCS 100 generates one or more program characteristics vector 150, which are comprised of program characteristics data 152, as illustrated in FIG. 1B. The program characteristics vector 150 is derived from the source related text 136 and/or from the EPG 140 by applying information retrieval techniques. The details of this process are discussed in accordance with FIG. 5A. The program characteristics data 152, which can be used to create the program characteristics vectors 150, both in vector and table form, are examples of source related information which represent characteristics of the source material 130. In a preferred embodiment, the program characteristics vectors 150 are lists of values which characterize the programming (source) material in accordance to the category 144, the sub-category 146, and the program description 148. The present invention may also be applied to advertisements, in which case, program characteristics vectors 150 contain, as an example, a product category, a product sub-category, and a brand name.

As illustrated in FIG. 1B, the SCS 100 uses heuristic rules 160. The heuristic rules 160, as described herein, are composed of both logical heuristic rules as well as heuristic rules expressed in terms of conditional probabilities. The heuristic rules 160 may be accessed by the SCS 100 via a request rules signal 162, which results in the transfer of a copy of rules 164 to the SCS 100.

The SCS 100 forms program demographic vectors 170 from program demographics 172, as illustrated in FIG. 1B. The program demographic vectors 170 also represent characteristics of source related information in the form of the intended or expected demographics of the audience for which the source material 130 is intended.

In a preferred embodiment, household viewing data 197, as illustrated in FIG. 1B, is computed from the actual subscriber selection data 199. The household viewing data 197 is derived from the actual subscriber selection data 199 by looking at viewing habits at a particular time of day over an extended period of time, usually several days or weeks, and making some generalizations regarding the viewing habits during that time period. The SCS 100 also transforms household viewing data 197 to form household viewing habits 195, i.e. statistical representation of subscriber/household viewing data illustrating patterns in viewing.

The program characteristics vector 150 is used in combination with a set of the heuristic rules 160 to define a set of program demographic vectors 170, describing the audience the program is intended for.

One output of the SCS 100 is a household profile including household demographic characteristics 190 and a household interest profile 180. The household demographic characteristics 190 resulting from the transfer of household demographic data 192, and the household interest profile 180, resulting from the transfer of household interests data 182. Both the household demographics characteristics 190 and the household interest profile 180 have a session value and an average value, as will be discussed herein.

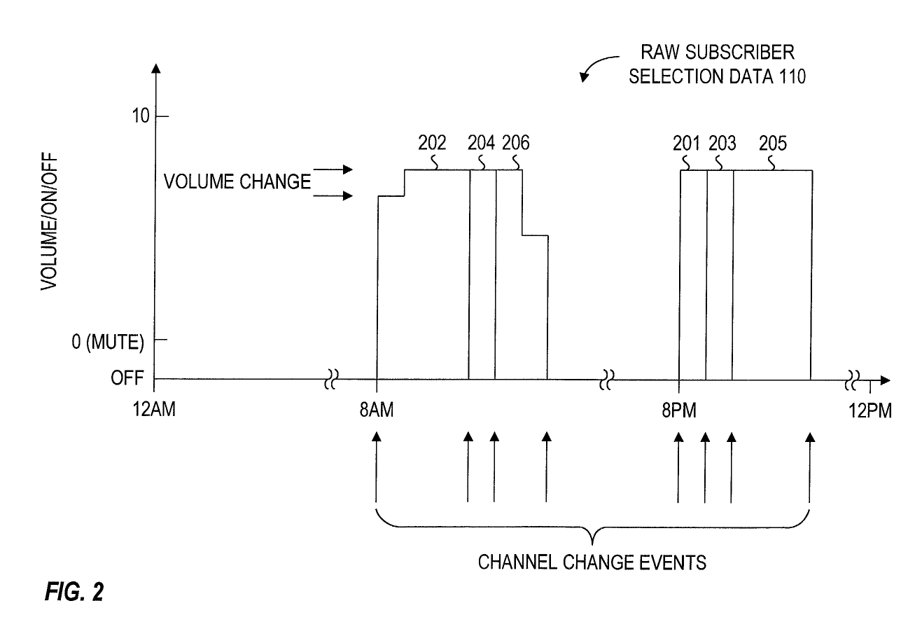

FIG. 2 illustrates a channel sequence and volume over a twenty-four (24) hour period of time. The Y-axis represents the status of the receiver in terms of on/off status and volume level. The X-axis represents the time of day. The channels viewed are represented by the windows 201-206, with a first channel 202 being watched, followed by the viewing of a second channel 204, and a third channel 206 in the morning. In the evening, a fourth channel 201, a fifth channel 203 and a sixth channel 205 are watched. A channel change is illustrated by a momentary transition to the “off” status and a volume change is represented by a change of level on the Y-axis.

FIG. 3A is a table illustrating a detailed record of the raw subscriber selection data 110 (shown in FIG. 1B). A time column 302 contains the starting time of every event occurring during the viewing time. A channel ID column 304 lists the channels viewed or visited during that period. A program title column 303 contains the titles of all programs viewed. A volume column 301 contains the volume level at the time of viewing a selected channel.

Generally, the raw subscriber selection data 110 is unprocessed data and comprises the data associated with irrelevant or inconsequential activities, e.g., channel surfing, channel jumping, or dead activities. Thus, before the subscriber/household viewing habits 195 are determined, the raw subscriber selection data 110 is filtered to eliminate the data associated with irrelevant (inconsequential) activities such as channel surfing, channel jumping, or dead period activities.

As illustrated in FIG. 3B, channel surfing relates to an activity wherein the subscriber 120 rapidly changes channels before arriving at a channel of interest to him. During the channel surfing period, the viewing time of each intermediate channel is very brief, e.g., less than one minute. In this viewing time, the subscriber 120 briefly glances at the channel programming, and then moves on to the next channel.

One or more filters of the present invention are configured to filter out the surfing activity and only the actual viewing activity is considered in the actual make-up of household viewing habits 195. For example, in FIG. 3B, the viewing record illustrates that the viewing time of each of the channels 2, 3, 4, 5 is less than a minute, however, the viewing time of channel 6 is about an hour. The filter of the present invention evaluates this record, and then removes the corresponding viewing times of channel 2, 3, 4, 5 from the viewing records. The viewing time of channel number 6 is kept, as it is not indicative of channel surfing but is an actual viewing.

Similarly, the viewing record also indicates that the corresponding viewing times of each of channel numbers 7, 8, 9, 58, 57, 56, 55, 54, 53 are about one minute or less, however, the viewing time of channel 25 is about 10 minutes. This implies that after the subscriber 120 had completed the viewing of channel number 6, the subscriber 120 once again surfed the channels to find a programming of interest at channel 25.

Filters of the present invention are configured to evaluate the associated viewing times and to remove the data associated with the most of the channel surfing activities. For example, the viewing times of the channel numbers 7, 8, 9, 58, 57, 56, 55, 54, and 53 are removed, but, the viewing time associated with channel number 25 is kept. Similarly, the viewing times associated with channels 24, 23, 99, 98, 97, and 2 are eliminated (indicate channel surfing) and the viewing time of channel number 3 is kept.

FIG. 3C illustrates processing involved in the elimination of viewing times associated with the channel jumping activities. The channel jumping activity is different than a channel surfing activity in a sense that the subscriber 120 already knows the intended programming (and corresponding channel number) he wants to watch, and utilizes the channel up or channel down button to arrive at the intended channel.

The viewing time of all the intermediate channels during channel jumping activity are generally very brief (less than a second). Also, as the channel up or channel down button is utilized to reach the desired channels, generally, there exists an upwards or a downwards stream of channel changes, i.e., the subscriber 120 may jump through channels 2, 3, 4 and 5 to reach channel number 6 (an intended channel). Similarly, the subscriber 120 may jump through channel 7, 8, 9, 10, 11, 12, 13, 14, 15, and 16 to reach channel 17.

Filters of the present invention are configured to eliminate the channel jumping data from the actual viewing data. The filters generally evaluate the associated viewing times, and all the viewing times which correspond to channel jumping, e.g., are less than one second, are removed from the viewing records. In the exemplary case of FIG. 3C, the viewing times of channel 15, and 14 are removed, but the viewing time of channel 13 is kept. Similarly, the viewing times of channel 14, 15, 16, 17, 18, 19, 20, 21 are removed and the viewing time of channel 22 is kept.

The filters are also configured to eliminate data associated with dead activities, e.g., extended spans of inactivity. These extended spans of inactivity indicate that the subscriber 120 is not actively watching the programming, e.g., the subscriber has left the room, has gone to sleep, or is otherwise engaged in some other activity. These spans of inactivity may be determined by evaluating channel change commands, volume change commands, or other program selection commands issued by the subscriber 120. For example, if the evaluation of the viewing record indicates that the subscriber 120 has not issued any of the channel change, volume change, on/off, or any other program selection commands in last three hours, it is assumed that subscriber 120 is in an inactive condition, and the remaining viewing time of that viewing session is not considered in the make-up of the household viewing habits 195. Also, it is generally known that subscribers 120 often do not turn their televisions and other multimedia sources off before attending to some other activities, such as cooking in the kitchen, running to the nearby grocery store, or going to basement for a work-out, etc.

The filters of the present invention are constantly filtering out the irrelevant information associated with the channel surfing activities, channel jumping activities, or with the periods of inactivity, so that the data used for generating the household viewing habits 195 is more illustrative of the actual viewing habits. The actual subscriber selection data 199 is then used to create household viewing habits 195.

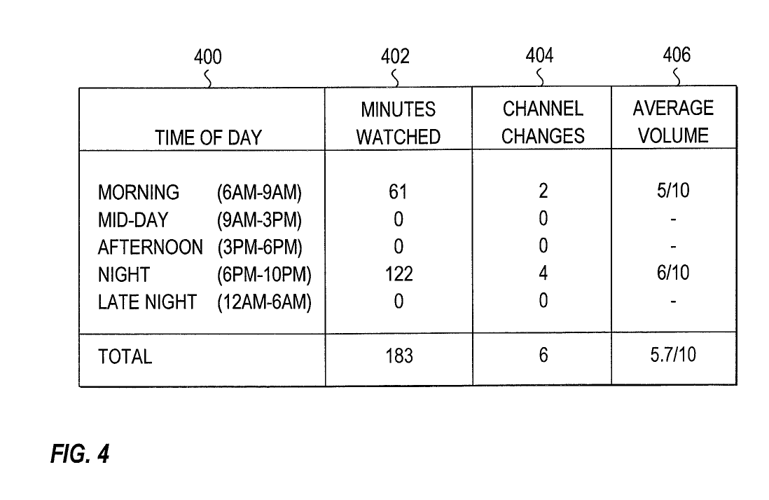

A representative statistical record corresponding to the household viewing habits 195 is illustrated in FIG. 4. In a preferred embodiment, a time of day column 400 is organized in period of time including morning, mid-day, afternoon, night, and late night. In an alternate embodiment, smaller time periods are used. Column 402 lists the number of minutes watched in each period. The average number of channel changes during that period are included in column 404. The average volume is also included in column 406. The last row of the statistical record contains the totals for the items listed in the minutes watched column 402, the channel changes column 404 and the average volume 406.

FIG. 5A illustrates an entity-relationship diagram for the generation of program characteristics vectors 150. The context vector generation and retrieval technique described in U.S. Pat. No. 5,619,709, by Caid, et al., which is incorporated herein by reference, can be applied for the generation of the program characteristics vectors 150. Other techniques are well known by those of ordinary skill in the art.

Referring to FIG. 5A, the source material 130 or the EPG 140 are passed through a program characterization process 500 to generate the program characteristics vectors 150. The program characterization process 500 is described in accordance with FIG. 5B. As shown in FIG. 5B, program content descriptors, including a first program content descriptor 502, a second program content descriptor 504 and an nth program content descriptor 506, each classified in terms of the category 144, the sub-category 146, and other divisions as identified in the industry accepted program classification system, are presented to a context vector generator 520. As an example, a program content descriptor 502, 504, 506 can be text, representative of the expected content of material found in the particular program category 144. In this example, the program content descriptors 502, 504 and 506 would contain text representative of what would be found in programs in the news, fiction, and advertising categories respectively. The context vector generator 520 generates context vectors for that set of sample texts resulting in a first summary context vector 508, a second summary context vector 510, and an n^{th} summary context vector 512. In the example given, the summary context vectors 508, 510, and 512 correspond to the categories of news, fiction and advertising respectively. The summary context vectors 508, 510 and 512 are stored in a local data storage system.

Referring to FIG. 5B, a sample of the source related text 136, which is associated with the new program to be classified is passed to the context vector generator 520 which generates a program context vector 540 for that program. The source related text 136 can be either the source material 130, the EPG 140, or other text associated with the source material 130. A comparison is made between the actual program context vectors and the stored program content context vectors by computing, in a dot product computation process 530, the dot product of the first summary context vector 508 with the program context vector 540 to produce a first dot product 514. Similar operations are performed to produce second dot product 516 and nth dot product 518.

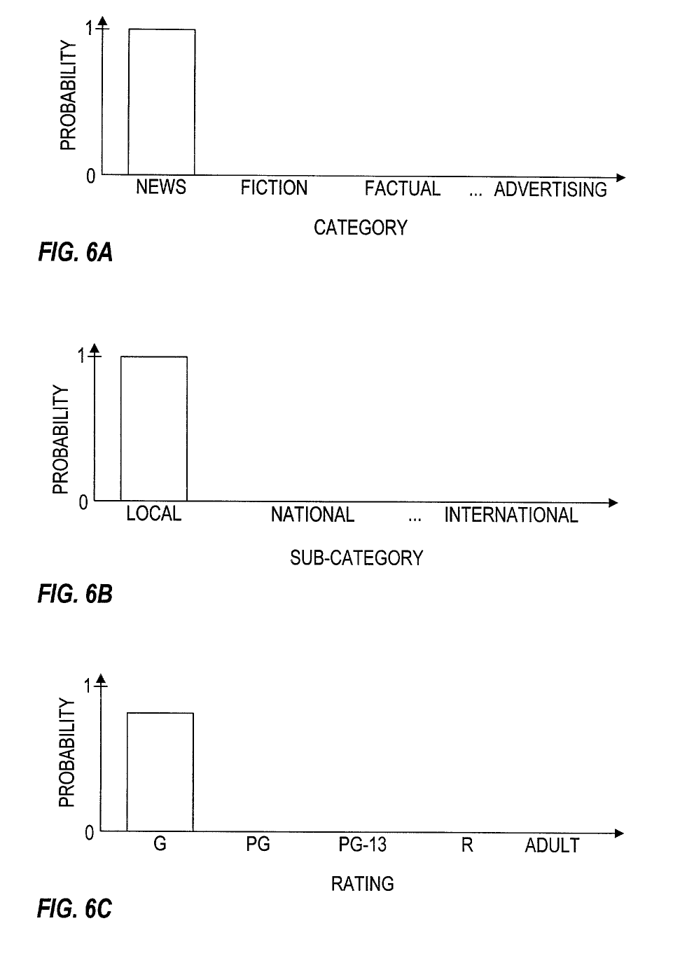

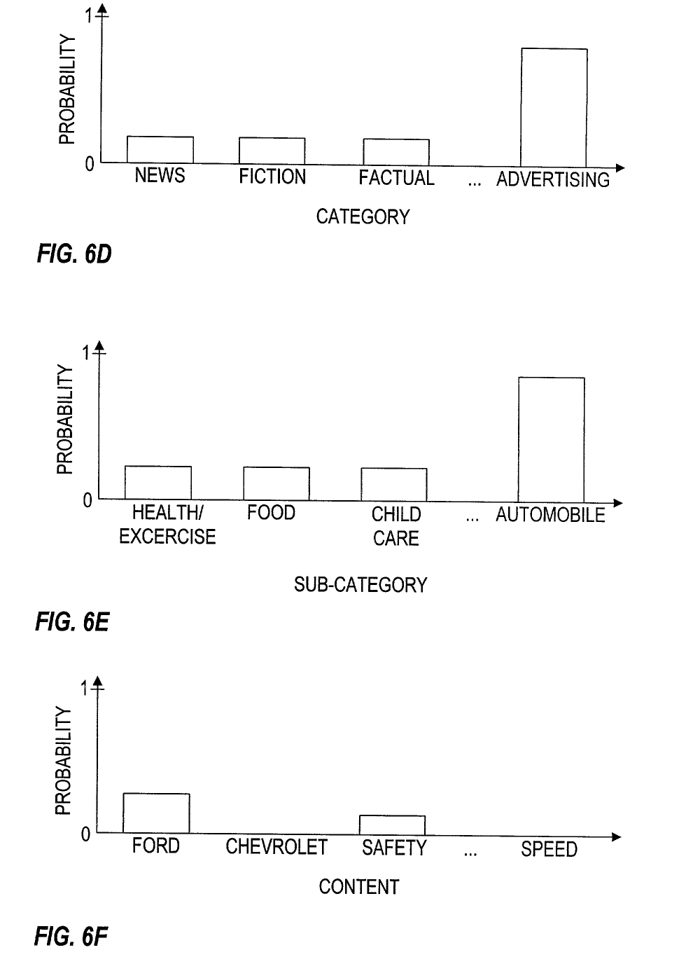

The values contained in the dot products 514, 516 and 518, while not probabilistic in nature, can be expressed in probabilistic terms using a simple transformation in which the result represents a confidence level of assigning the corresponding content to that program. The transformed values add up to one. The dot products can be used to classify a program, or form a weighted sum of classifications which results in the program characteristics vectors 150. In the example given, if the source related text 136 was from an advertisement, the n^{th} dot product 518 would have a high value, indicating that the advertising category was the most appropriate category, and assigning a high probability value to that category. If the dot products corresponding to the other categories were significantly higher than zero, those categories would be assigned a value, with the result being the program characteristics vectors 150 as shown in FIG. 6D.

For the sub-categories, probabilities obtained from the content pertaining to the same sub-category 146 are summed to form the probability for the new program being in that sub-category 146. At the sub-category level, the same method is applied to compute the probability of a program being from the given category 144. The three levels of the program classification system; the category 144, the sub-category 146 and the content, are used by the program characterization process 500 to form the program characteristics vectors 150 which are depicted in FIGS. 6D-6F.

The program characteristics vectors 150 in general are represented in FIGS. 6A through 6F. FIGS. 6A, 6B and 6C are examples of deterministic program vectors. This set of vectors is generated when the program characteristics are well defined, as can occur when the source related text 136 or the EPG 140 contains specific fields identifying the category 144 and the sub-category 146. A program rating can also provided by the EPG 140.

In the case that these characteristics are not specified, a statistical set of vectors is generated from the process described. FIG. 6D shows the probability that a program being watched is from the given category 144. The categories are listed in the X-axis. The sub-category 146 is also expressed in terms of probability. This is shown in FIG. 6E. The content component of this set of vectors is a third possible level of the program classification, and is illustrated in FIG. 6F.

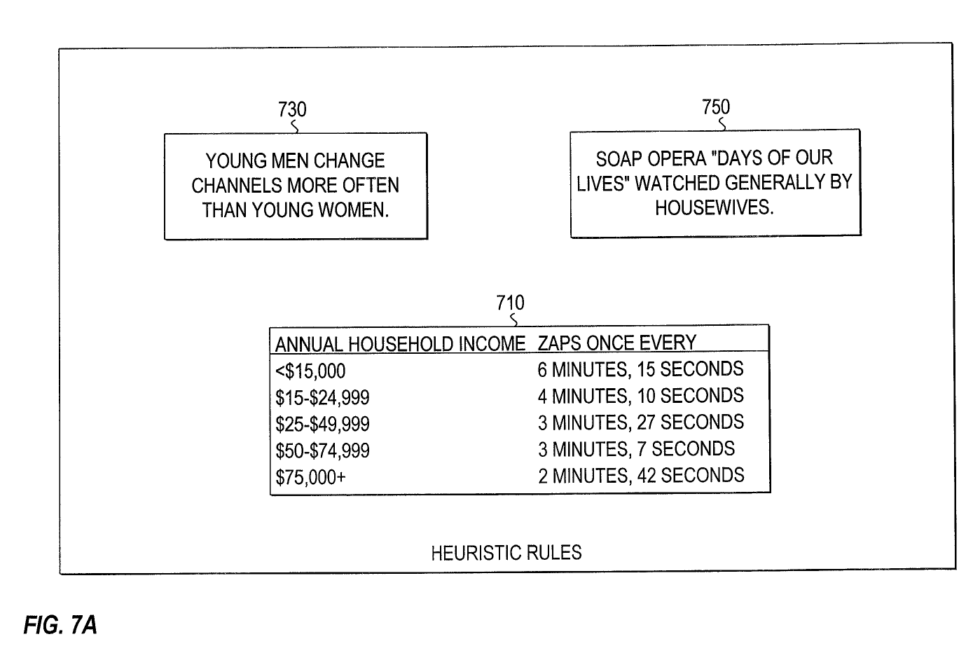

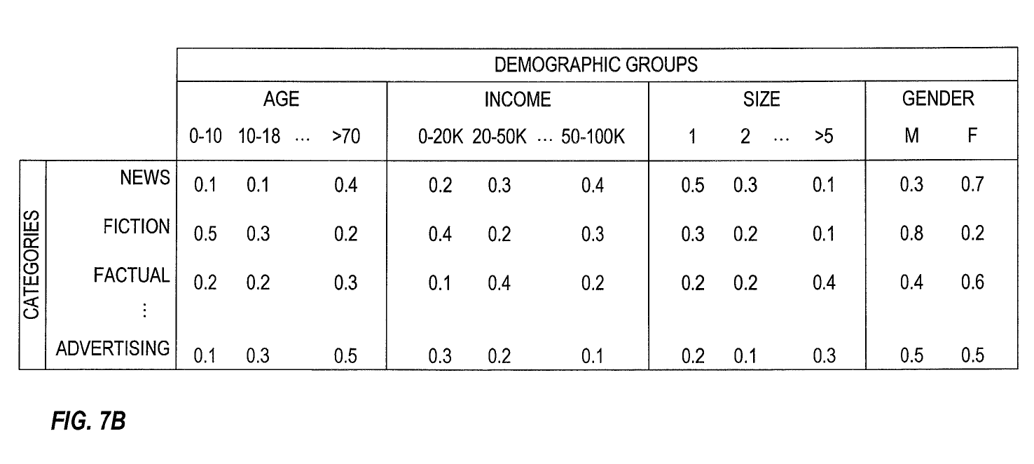

FIG. 7A illustrates sets of logical heuristics rules which form part of the heuristic rules 160. In a preferred embodiment, logical heuristic rules are obtained from sociological or psychological studies. Two types of rules are illustrated in FIG. 7A. The first type links an individual's viewing characteristics to demographic characteristics such as gender, age, and income level. A channel changing rate rule 730 attempts to determine gender based on channel change rate. An income related channel change rate rule 710 attempts to link channel change rates to income brackets. A second type of rules links particular programs to particular audience, as illustrated by a gender determining rule 750 which links the program category 144/sub-category 146 with a gender. The result of the application of the logical heuristic rules illustrated in FIG. 7A are probabilistic determinations of factors including gender, age, and income level. Although a specific set of logical heuristic rules has been used as an example, a wide number of types of logical heuristic rules can be used to realize the present invention. In addition, these rules can be changed based on learning within the system or based on external studies which provide more accurate rules.

FIG. 7B illustrates a set of the heuristic rules 160 expressed in terms of conditional probabilities. In the example shown in FIG. 7B, the category 144 has associated with it conditional probabilities for demographic factors such as age, income, family size and gender composition. The category 144 has associated with it conditional probabilities that represent probability that the viewing group is within a certain age group dependent on the probability that they are viewing a program in that category 144.

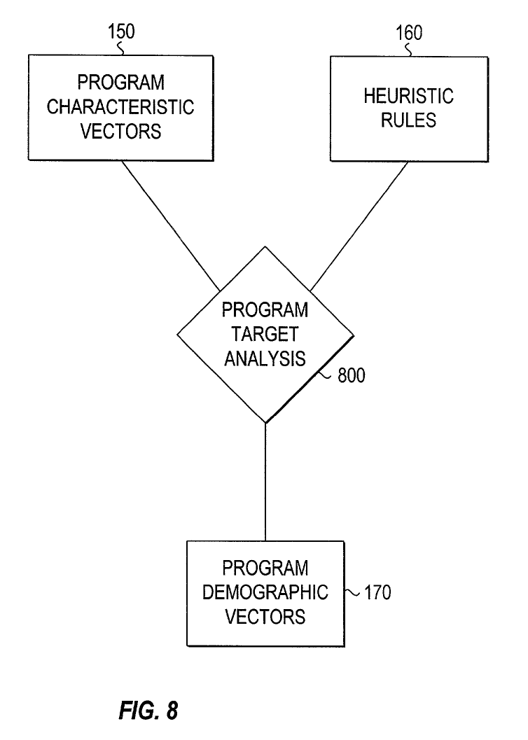

FIG. 8 illustrates an entity-relationship diagram for the generation of program demographic vectors 170. In a preferred embodiment, the heuristic rules 160 are applied along with the program characteristic vectors 150 in a program target analysis process 800 to form the program demographic vectors 170. The program characteristic vectors 150 indicate a particular aspect of a program, such as its violence level. The heuristic rules 160 indicate that a particular demographic group has a preference for that program. As an example, it may be the case that young males have a higher preference for violent programs than other sectors of the population. Thus, a program which has the program characteristic vectors 150 indicating a high probability of having violent content, when combined with the heuristic rules 160 indicating that “young males like violent programs,” will result, through the program target analysis process 800, in the program demographic vectors 170 which indicate that there is a high probability that the program is being watched by a young male.

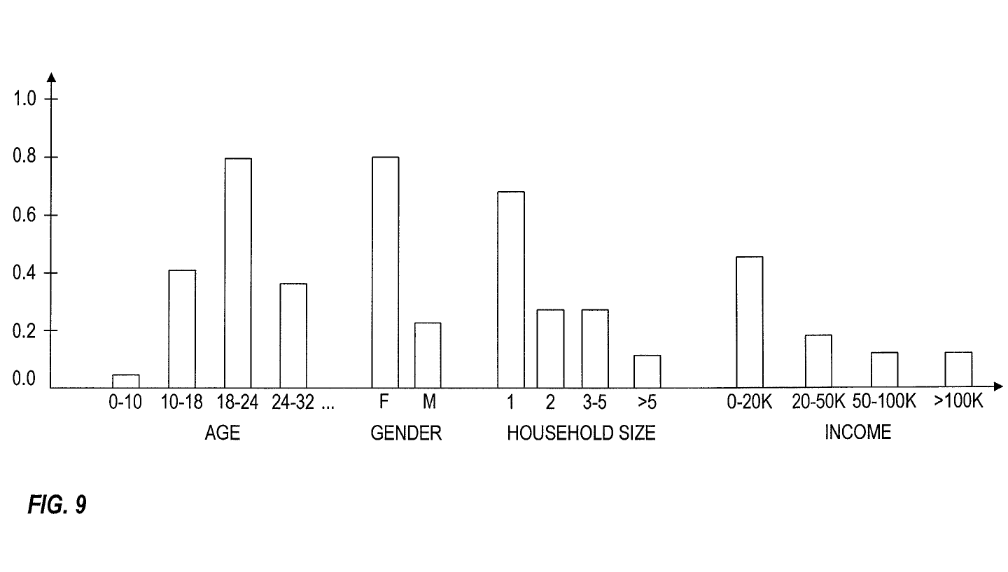

The program target analysis process 800 can be realized using software programmed in a variety of languages which processes mathematically the heuristic rules 160 to derive the program demographic vectors 170. The table representation of the heuristic rules 160 illustrated in FIG. 7B expresses the probability that the individual or household is from a specific demographic group based on a program with a particular category 144. This can be expressed, using probability terms as follow “the probability that the individuals are in a given demographic group conditional to the program being in a given category”. Referring to FIG. 9, the probability that a group has certain demographic characteristics based on the program being in a specific category is illustrated.

Expressing the probability that a program is destined to a specific demographic group can be determined by applying Bayes rule. This probability is the sum of the conditional probabilities that the demographic group likes the program, conditional to the category 144 weighted by the probability that the program is from that category 144. In a preferred embodiment, the program target analysis 800 can calculate the program demographic vectors 170 by application of logical heuristic rules, as illustrated in FIG. 7A, and by application of heuristic rules 160 expressed as conditional probabilities as shown in FIG. 7B. Logical heuristic rules 160 can be applied using logical programming and fuzzy logic using techniques well understood by those of ordinary skill in the art, and are discussed in the text by S. V. Kartalopoulos entitled “Understanding Neural Networks and Fuzzy Logic”, which is incorporated herein by reference.

Conditional probabilities can be applied by simple mathematical operations multiplying program context vectors by matrices of conditional probabilities. By performing this process over all the demographic groups, the program target analysis process 800 can measure how likely a program is to be of interest to each demographic group. Those probabilities values form the program demographic vector 170 represented in FIG. 9.

As an example, the heuristic rules 160 expressed as conditional probabilities shown in FIG. 7B are used as part of a matrix multiplication in which the program characteristics vector 150 of dimension N, such as those shown in FIGS. 6A-6F is multiplied by an N×M matrix of heuristic rules 160 expressed as conditional probabilities, such as that shown in FIG. 7B. The resulting vector of dimension M is a weighted average of the conditional probabilities for each category and represents the household demographic characteristics 190. Similar processing can be performed at the sub-category and content levels.

FIG. 9 illustrates an example of the program demographic vector 170, and shows the extent to which a particular program is destined to a particular audience. This is measured in terms of probability as depicted in FIG. 9. The Y-axis is the probability of appealing to the demographic group identified on the X-axis.

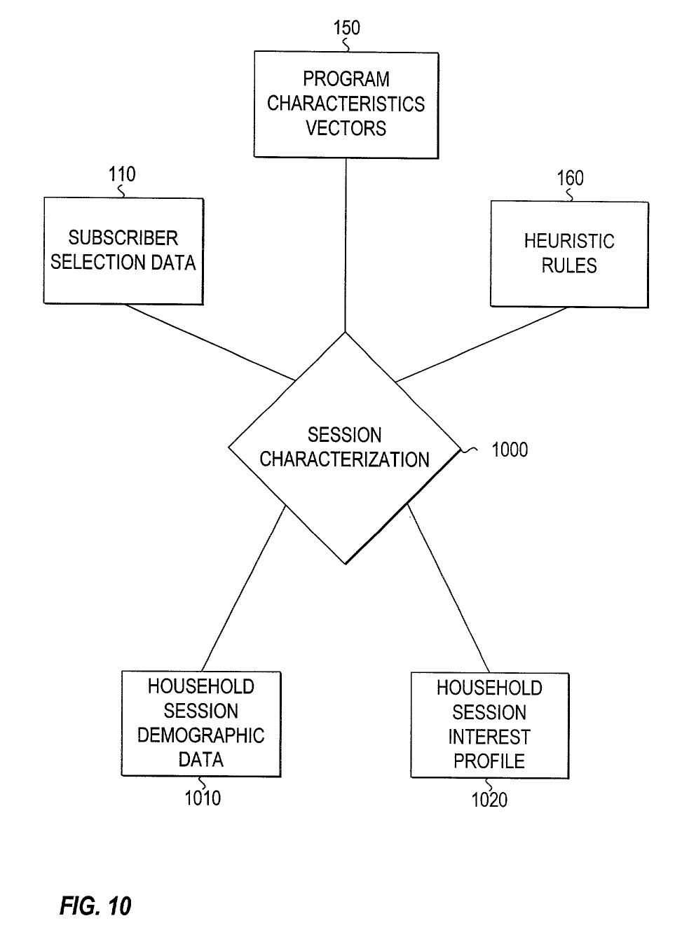

FIG. 10 illustrates an entity-relationship diagram for the generation of household session demographic data 1010 and household session interest profile 1020. In a preferred embodiment, the actual subscriber selection data 199 is used along with the program characteristics vectors 150 in a session characterization process 1000 to generate the household session interest profile 1020. The actual subscriber selection data 199 indicates what the subscriber 120 is watching, for how long and at what volume they are watching the program.

In a preferred embodiment, the session characterization process 1000 forms a weighted average of the program characteristics vectors 150 in which the time duration the program is watched is normalized to the session time (typically defined as the time from which the unit was turned on to the present). The program characteristics vectors 150 are multiplied by the normalized time duration (which is less than one unless only one program has been viewed) and summed with the previous value. Time duration data, along with other subscriber viewing information, is available from the actual subscriber selection data 199. The resulting weighted average of the program characteristics vectors 150 forms the household session interest profile 1020, with each program contributing to the household session interest profile 1020 according to how long it was watched. The household session interest profile 1020 is normalized to produce probabilistic values of the household programming interests during that session.

In an alternate embodiment, the heuristic rules 160 are applied to both the actual subscriber selection data 199 and the program characteristics vectors 150 to generate the household session demographic data 1010 and the household session interest profile 1020. In this embodiment, weighted averages of the program characteristics vectors 150 are formed based on the actual subscriber selection data 199, and the heuristic rules 160 are applied. In the case of logical heuristic rules as shown in FIG. 7A, logical programming can be applied to make determinations regarding the household session demographic data 1010 and the household session interest profile 1020. In the case of heuristic rules 160 in the form of conditional probabilities such as those illustrated in FIG. 7B, a dot product of the time averaged values of the program characteristics vectors 150 can be taken with the appropriate matrix of heuristic rules 160 to generate both the household session demographic data 1010 and the household session interest profile 1020.

Volume control measurements, which form part of the actual subscriber selection data 199 can also be applied in the session characterization process 1000 to form a household session interest profile 1020. This can be accomplished by using normalized volume measurements in a weighted average manner similar to how time duration is used. Thus, muting a show results in a zero value for volume, and the program characteristics vector 150 for this show will not be averaged into the household session interest profile 1020.

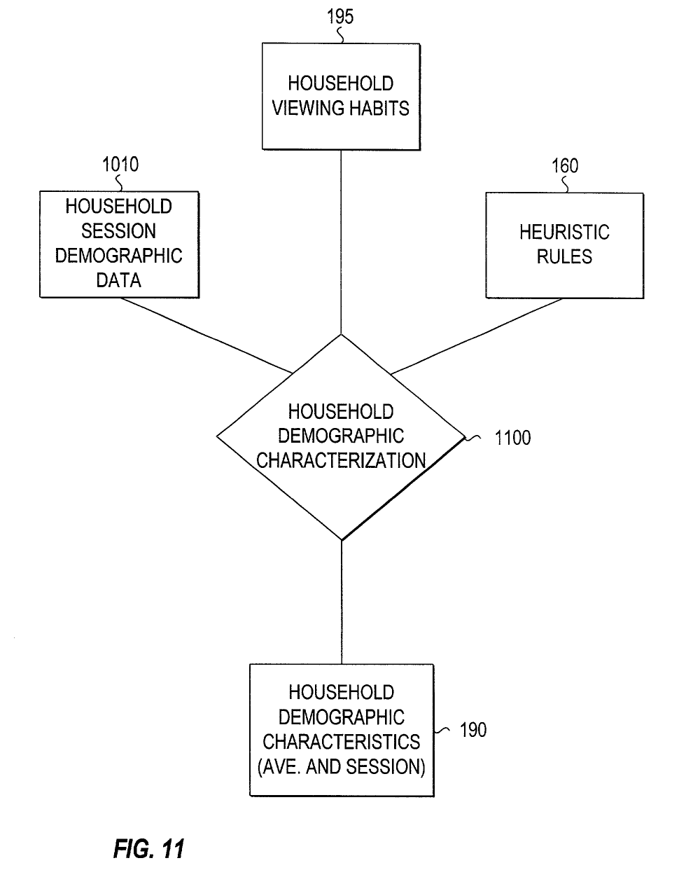

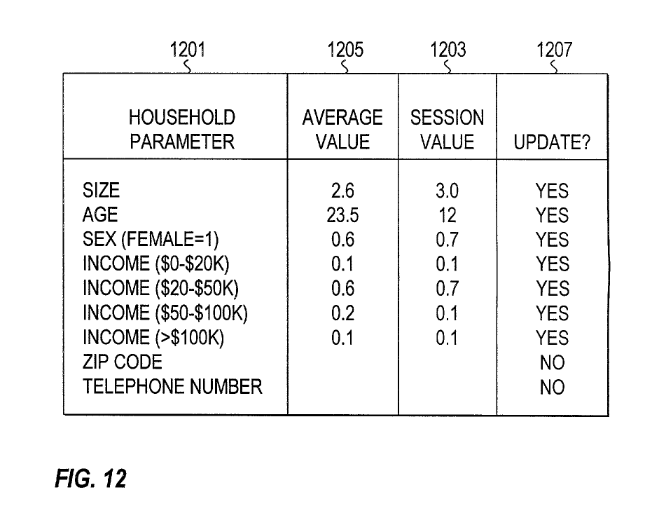

FIG. 11 illustrates an entity-relationship diagram for the generation of average household demographic characteristics and session household demographic characteristics 190. A household demographic characterization process 1100 generates the household demographic characteristics 190 represented in table format in FIG. 12. The household demographic characterization process 1100 uses the household viewing habits 195 in combination with the heuristic rules 160 to determine demographic data. For example, a household with a number of minutes watched of zero during the day may indicate a household with two working adults. Both logical heuristic rules as well as rules based on conditional probabilities can be applied to the household viewing habits 195 to obtain the household demographics characteristics 190.

The household viewing habits 195 is also used by the system to detect out-of-habits events. For example, if a household with a zero value for the minutes watched column at late night presents a session value at that time via the household session demographic data 1010, this session will be characterized as an out-of-habits event and the system can exclude such data from the average if it is highly probable that the demographics for that session are greatly different than the average demographics for the household. Nevertheless, the results of the application of the household demographic characterization process 1100 to the household session demographic data 1010 can result in valuable session demographic data, even if such data is not added to the average demographic characterization of the household.

FIG. 12 illustrates the average and session household demographic characteristics 190. A household demographic parameters column 1201 is followed by an average value column 1205, a session value column 1203 and an update column 1207. The average value column 1205 and the session value column 1203 are derived from the household demographic characterization process 1100. The deterministic parameters such as address and telephone numbers can be obtained from an outside source or can be loaded into the system by the subscriber 120 or a network operator at the time of installation. Updating of deterministic values is prevented by indicating that these values should not be updated in the update column 1207.

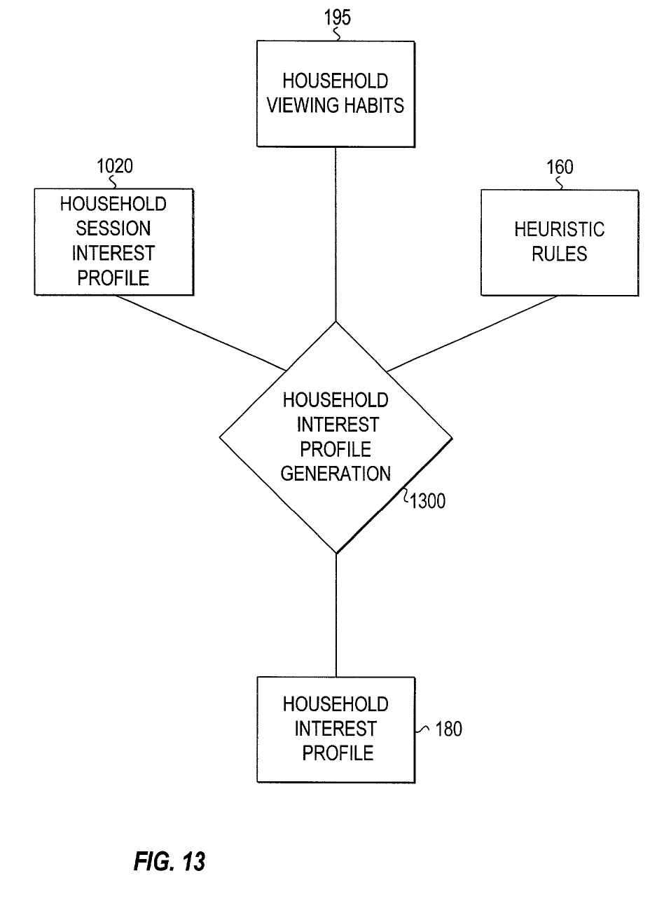

FIG. 13 illustrates an entity-relationship diagram for the generation of the household interest profile 180 in a household interest profile generation process 1300. In a preferred embodiment, the household interest profile generation process 1300 comprises averaging the household session interest profile 1020 over multiple sessions and applying the household viewing habits 195 in combination with the heuristic rules 160 to form the household interest profile 180, which takes into account both the viewing preferences of the household as well as assumptions about households/subscribers with those viewing habits and program preferences.

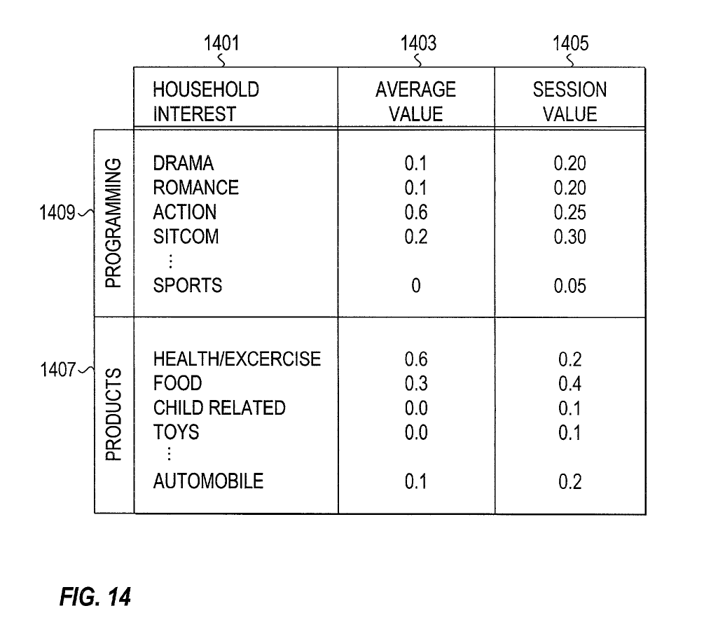

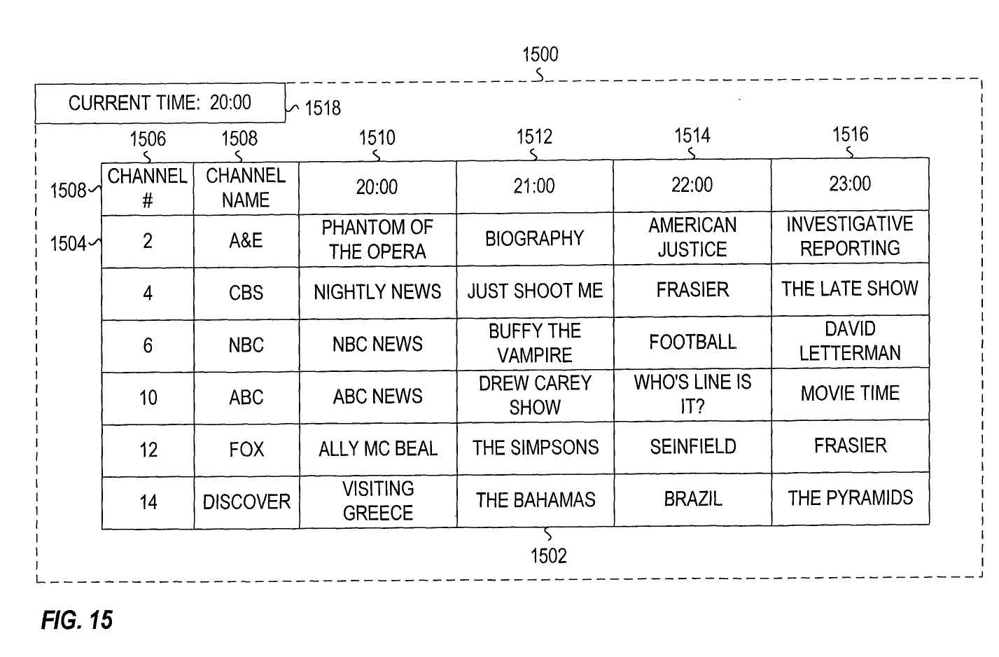

FIG. 14 illustrates the household interest profile 180 which is composed of a programming types row 1409, a products types row 1407, and a household interests column 1401, an average value column 1403, and a session value column 1405.

The product types row 1407 gives an indication as to what type of advertisement the household would be interested in watching, thus indicating what types of products could potentially be advertised with a high probability of the advertisement being watched in its entirety. The programming types row 1409 suggests what kind of programming the household is likely to be interested in watching. The household interests column 1401 specifies the types of programming and products which are statistically characterized for that household.

As an example of the industrial applicability of the invention, a household will perform its normal viewing routine without being requested to answer specific questions regarding likes and dislikes. Children may watch television in the morning in the household, and may change channels during commercials, or not at all. The television may remain off during the working day, while the children are at school and day care, and be turned on again in the evening, at which time the parents may “surf” channels, mute the television during commercials, and ultimately watch one or two hours of broadcast programming. The present invention provides the ability to characterize the household based on actual viewing selections, e.g., channel surfing, channel jumping or dead periods are not considered. Based on the actual subscriber selection data 199, the determinations are made that there are children and adults in the household, and program and product interests indicated in the household interest profile 180 corresponds to a family of that composition. For example, a household with two retired adults will have a completely different characterization which will be indicated in the household interest profile 180.

The information from the SCS 100 is utilized by the EPGS 102 to generate one or more EPG screens that are individually created (configures) based on subscriber characterizations.

The EPG screen contains information about one or more channels, wherein the channel information is organized in an order based on subscriber 120 preferences, i.e., the programming found to be most applicable to the subscriber profile is shown first. For example, if the subscriber profile illustrates that the subscriber 120 prefers art-related movies, then the information about art movies is illustrated first. It is to be noted that the subscriber characterizations are used to present what is, to the subscriber 120, the preferred programming as well as the programming that may be of interest to the subscriber 120 based on subscriber characterizations.

FIG. 15 demonstrates how a typical EPG display 1500 may appear without using the novel subscriber profile of the present invention. The EPG display 1500 consists of a table 1502 containing rows 1504 representing available television channels and columns 1506 representing time periods. The order in which the available television channels appear in rows 1504 by channel number. The top row indicates channel number 1506, channel name 1508, programming name and times of play 1510, 1512, 1514, 1516. The current time 1518 is shown. It can be seen in FIG. 15 that a subscriber 120 who prefers viewing, for example, the Discover Channel, will have to scroll through the entire table 1502 to learn what is offered on the subscriber's preferred channels.

In accordance with the present invention, the information captured by the subscriber profile can be used by an EPG 140 to tailor display the 1500 so as to provide faster access to information concerning the subscriber's preferred channels and/or programming categories. Thus, rows 1504 may be configured by an EPG 140 in accordance with the subscriber profile such that preferred channels or preferred categories of programming are displayed at the top of table 1502, and may be easily selected by a subscriber 120.

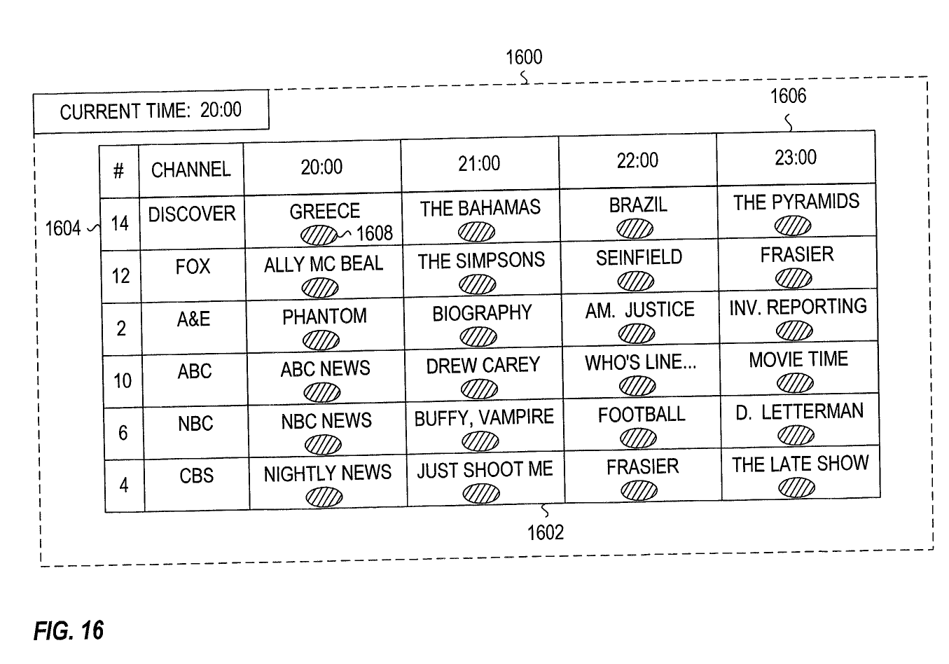

FIG. 16 illustrates a display 1600 of an EPG 140 in accordance with the principles of the present invention. As shown in FIG. 16, channels may be aligned, overlaid upon primary television display 1600 containing rows 1604 representing television channels and columns 1606 representing time periods with channels being organized based on subscriber preferences. The channels that are of interest or may be of interest to the subscriber 120 are shown first. In one embodiment, each box representing a program on a particular channel for a particular time, includes an information box 1608. Using the subscriber interface remote control, a subscriber 120 can examine more information about a particular program by clicking on the information box 1608.

The EPG display of FIG. 16 can operate in conjunction with the subscriber profile of the present invention to organize the individual channels in row 1602 by subscriber characterization. Unlike prior art where channels are organized by the channel number, the individual channels in the present invention are organized based on subscriber characterization, i.e., the channels that are of interest to the subscriber 120 or may be of interest to the subscriber 120, are arranged in an order of preference, the channels most applicable are listed first and the channels least applicable are listed last. The subscriber profile of the present invention may also be used by the EPG 120 to automatically surf through the subscriber's 120 preferred channels or through those channels presently showing the subscriber's 120 favorite category or categories of programming. Thus, the subscriber profile of the present invention, in conjunction with the EPG of FIG. 16, can receive and execute a subscriber-initiated command to surf automatically, without further subscriber 120 intervention, through the television channels represented by current entries in subscriber profile array. This allows a subscriber 120 to glimpse the programs currently playing on the subscriber's 120 favorite channels or the programs in the subscriber's 120 favorite categories with only one keypress of the remote control and stop surfing on one of these favorite channels with one more keypress. One of ordinary skill in the art will understand that views of the preferred channels being surfed through need not occupy the entire display of the television. Thus, for example, as shown in FIG. 16, a cursor may automatically step through the subscriber's 120 preferred channels while the subscriber 120 is still watching primary television display. However, the subscriber profile of the present invention may also be used to step through preferred channels in primary display with no EPG displayed on the television screen.

In yet another exemplary embodiment of the present invention, the information stored in the subscriber profile is made available to interested broadcasters. The broadcasters in turn use the information to more appropriately target certain types of programming and commercials to certain individuals or communities.

The subscriber profile can also be used to identify channels that a subscriber 120 has not been watching, but that contain content the subscriber 120 might find interesting. Thus, for example, if from the subscriber profile it is determined that a particular subscriber 120 enjoys watching movies, the subscriber 120 will be notified when movies are showing on channels not commonly watched by that subscriber 120. These channels may be identified automatically on a periodic basis, or could be provided upon a subscriber 120 request.

Similarly, the subscriber profile can be used to identify and provide information from the Internet, including the World Wide Web, to a subscriber. This application of the subscriber profile is highly advantageous as the delivery models of a personal computer and a television are on opposite ends of the interactive spectrum. More particularly, the personal computer is a “pull” model medium, in that the personal computer does nothing until the subscriber boots up the computer and enter appropriate commands. Each used command may produce lengthy interactions, but regardless of length, the subscriber controls the navigation and presentation of information. Simply put, the subscriber “pulls”, the information from the personal computer or the Internet.

Unlike the personal computer, the television is a “push” model medium, in that television broadcasts are pushed at the consumer. Except for the ability to change channels or purchase on-demand videos, the subscriber does not control the information stream from the broadcaster. This “push” model is desirable in the entertainment industry where surprise is the key to engaging the audience.

Accordingly, keeping track of viewing habits through the subscriber profile array is instrumental in combining the features of the television and the Internet without relying on the personal computer “push” model of interaction. As explained herein, the subscriber profile is a compilation of the most recently viewed and most often viewed channels, programming categories, and programming subcategories for each subscriber. This subscriber profile information can be used, in conjunction with for example a known Internet search engine, to search for and “pull” information from the Internet that might be interesting to a particular subscriber. The located information may then be “pushed” at the subscriber in accordance with the television model of interaction.

The information pulled from the Internet may be presented to the subscriber in a variety of formats. For example, a small icon on the television screen can appear discreetly whenever something of interest is available. Alternatively, a running banner across the screen can appear giving small pieces of information about additional information available on the Internet.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

what is claimed is:

1. A method for providing user-friendly Electronic Program Guide (EPG) screens to a subscriber of television or multimedia programming, the method comprising:
monitoring subscriber viewing activities;
collecting raw subscriber selection data based on source material selected by the user over a predetermined period of time;
evaluating the raw subscriber selection data to filter out irrelevant data and generate a record of actual subscriber selection data;
processing the actual subscriber selection data to create a subscriber profile, and
configuring a customized EPG screen based on the subscriber profile, wherein the EPG screen is transmitted to the subscriber.

2. The method of claim 1, wherein the EPG screen includes information about one or more program channels.

3. The method of claim 2, wherein program channels are arranged in an order of preference based on the subscriber profile.

4. The method of claim 1, further comprising:
determining one or more channels that may be of interest to the subscriber; and
rearranging the EPG screen to present the channels of interest first.

5. The method of claim 1, wherein said monitoring comprises monitoring volume control commands initiated by the subscriber.

6. The method of claim 1, wherein said monitoring comprises monitoring channel change commands initiated by the subscriber.

7. The method of claim 1, wherein said monitoring comprises monitoring record signals initiated by the subscriber.

8. The method of claim 1, wherein said collecting comprises extracting source related text from the source material.

9. The method of claim 8, wherein the source related text includes one or more descriptive fields.

10. The method of claim 8, wherein the source related text is extracted from an electronic program guide of the source material.

11. The method of claim 8, wherein the source related text is extracted from one or more HTML files related to the source material.

12. The method of claim 8, wherein the source related text is extracted form the close captioning information of the source material.

13. The method of claim 1, wherein s aid collecting further comprises monitoring time durations corresponding to viewing times of selected source material.

14. The method of claim 1, wherein said evaluating comprises evaluating channel change commands and associated viewing times.

15. The method of claim 14, further comprising filtering out any channel change commands if the associated viewing times are below a pre-determined threshold.

16. The method of claim 15, wherein the filtered out channel change commands correspond to channel surfing activities.

17. The method of claim 15, wherein the filtered out channel change commands correspond to channel jumping activities.

18. The method of claim 1, wherein said evaluating comprises evaluating viewing times and filtering out any viewing periods if no user activity has been received within a predetermined period of time.

19. The method of claim 18, wherein the filtered out viewing periods correspond to dead periods implying that the subscriber is not actively watching the television or multimedia programming.

20. The method of claim 1, wherein said processing comprises generating one or more program characteristics vectors based on the subscriber selection data.

21. The method of claim 20, wherein the program characteristics vectors are one or more values characterizing the source material.

22. The method of claim 1, wherein said processing corresponds to an n-dimensional program characteristics matrix comprising one or more program characteristics vectors.

23. The method of claim 1, wherein said processing further comprises processing subscriber selection data based on a predetermined set of heuristic rules.

24. The method of claim 23, wherein the heuristic rules are described in logical forms.

25. The method of claim 23, wherein the heuristic rules are expressed as conditional probabilities.

26. The method of claim 1, wherein the subscriber profile is a profile based on the user interests.

27. The method of claim 1, wherein the subscriber belongs to a household and the subscriber profile is a profile based on the interests of the user household.

28. The method of claim 1, wherein the subscriber belongs to a household and the subscriber profile is a demographic profile for the user, the demographic profile indicating the probable age, income, gender, and other demographics.

29. The method of claim 1, wherein the subscriber selection data corresponds to a viewing session and the subscriber profile is a session demographic profile for the user.

30. The method of claim 1, wherein the subscriber selection data corresponds to a plurality of viewing sessions and the subscriber profile is an average demographic profile for the subscriber.

31. The method of claim 1, wherein the subscriber profile is a program preference profile for the subscriber, the program preference profile indicating the type of programming of interest to the subscriber.

32. The method of claim 1, wherein the subscriber profile is a product preference profile for the subscriber.

33. The method of claim 1, wherein the subscriber belongs to a household and the subscriber profile comprises household demographic data indicating probabilistic measurements of household demographics.

34. The method of claim 1, wherein the subscriber belongs to a household and the subscriber profile comprises household program preference information indicating probabilistic measurements of household program interests.

35. The method of claim 1, wherein the subscriber belongs to a household and the subscriber profile comprises household product preference information indicating probabilistic measurements of household product interests.

36. The method of claim 1, wherein the subscriber selection data corresponds to a viewing session of the subscriber household and the subscriber profile is a session demographic profile for the subscriber household.

37. The method of claim 1, wherein the subscriber selection data corresponds to a plurality of viewing sessions and the subscriber profile is an average demographic profile for the subscriber household.

38. The method of claim 1, wherein the subscriber profile is controlled by the subscriber.

39. The method of claim 1, wherein the subscriber profile is analyzed by a third party for the purposes of marketing and advertising.

40. The method of claim 1, wherein access to the subscriber profile is limited to a selected number of other parties.

41. The method of claim 1, further comprising analyzing the subscriber profile to estimate user viewing habits.

42. A data processing system for generating a customized electronic program guide (EPG) for a subscriber of television programming, the data processing system comprising:
a storage medium;
means for monitoring subscriber activity and creating a record of raw subscriber selection data wherein the raw subscriber selection data corresponds to the source material selected by the subscriber;
means for evaluating the raw subscriber selection data and filtering out the selection data associated with irrelevant activities and for creating a record of an actual subscriber selection data;
means for retrieving source related information wherein the source related information contains descriptive fields corresponding to the actual subscriber selection data;
means for processing the actual subscriber selection data with respect to the descriptive fields to form a subscriber profile; and
means for receiving the subscriber profile and generating a customized EPG screen based on the subscriber profile.

43. The method of claim 42, wherein the EPG screen includes information about one or more program channels.

44. The method of claim 43, wherein program channels are arranged in an order of preference based on the subscriber profile.

45. The system of claim 42, wherein the means for monitoring subscriber activity further comprises means for monitoring time durations wherein the time durations correspond to viewing times of the selected source material.

46. The system of claim 42, wherein the means for monitoring subscriber activity further comprises means for monitoring volume levels wherein the volume levels correspond to subscriber selection volume levels.

47. The system of claim 42, wherein the means for processing includes pre-determined heuristics rules.

48. The system of claim 42, wherein the means for evaluating filters out the selection data associated with channel surfing activities.

49. The system of claim 48, wherein the channel surfing activities are recognized by recognizing the channel change commands issued by the subscriber and then evaluating the associated viewing times.

50. The system of claim 42, wherein the means for evaluating filters out the selection data associated with channel jumping activities.

51. The system of claim 50, wherein the channel jumping activities are recognized by recognizing the channel change commands issued by the subscriber and then evaluating the associated channel numbers and viewing times.

52. The system of claim 42, wherein the means for evaluating filters out the selection data associated with dead periods.

53. The system of claim 52, wherein the dead periods are recognized by recognizing the channel change commands or volume change commands issued by the subscriber and then evaluating the associated viewing times.

54. The system of claim 42, wherein the subscriber profile contains household demographic data indicating probabilistic measurements of household demographics.

55. The system of claim 42, wherein the subscriber profile contains household program preference information indicating probabilistic measurements of household program interests.

56. The system of claim 42, wherein the subscriber profile contains household product preference information indicating probabilistic measurements of household product interests.
